(19) United States
(12) Patent Application Publication
(10) Pub. No.: US 2026/0106680 A1
(43) Pub. Date: Apr. 16, 2026

(54) METHOD FOR PROVIDING A POWER DELAY PROFILE FOR A FADING SIMULATOR

(71) Applicant: Rohde & Schwarz GmbH & Co. KG, München (DE)

(72) Inventor: Stefan Schmidt, München (DE)

(21) Appl. No.: 18/912,543

(22) Filed: Oct. 10, 2024

(51) Int. Cl. H04B 17/364

(52) U.S. Cl. CPC H04B 17/364

(57) ABSTRACT

The present invention relates to a method for providing a power delay profile for a fading simulator of a test setup, wherein the power delay profile comprises a predefined set of taps, wherein each tap represents a signal path and has a tap power level and a tap time delay, wherein the delay resolution of the power delay profile is determined as an integer multiple of the reciprocate value of a bandwidth of a signal to be faded by the fading simulator of said test setup or is determined as an integer multiple of the reciprocate value of a fader sampling rate of the fading simulator of said test setup.

### TECHNICAL FIELD

The present invention relates to a method for providing a power delay profile for a fading simulator of a test setup used to test a performance of a device under fading conditions.

### TECHNICAL BACKGROUND

The quality of wireless communication between a transmitter and a receiver depends on the radio channel characteristics. The radio channel is susceptible to noise, interference, and fading (path loss, shadowing and multipath propagation). For this reason wireless devices under test DUTs such as mobile phones must be tested under real-world conditions to verify their performance.

Communications standards stipulate tests under fading conditions. The specified fading scenarios take power delay profiles PDPs as a basis to model fading conditions. The specified power delay profiles PDPs can be reproduced using a channel simulator. Test and measurement equipment make it possible to perform such tests. A fading simulator reproduces well-defined and repeatable real world test scenarios in a laboratory.

However, delays defined in an original power delay profile PDP as specified in a communication standard may only be met accurately at a high hardware cost. This means that a significant amount of the processing power of a test instrument is reserved solely for the channel modelling. This is a severe technical drawback especially for those tests which require that numerous signaling cells need to be setup.

### SUMMARY

The invention provides according to a first aspect a method for providing a power delay profile for a fading simulator of a test setup, wherein the power delay profile comprises a predefined set of taps, wherein each tap represents a signal path and has a tap power level and a tap time delay, wherein the delay resolution of the power delay profile is determined as an integer multiple of the reciprocate value of a bandwidth of a signal to be faded by the fading simulator of said test setup or is determined as an integer multiple of the reciprocate value of a fader sampling rate of the fading simulator of said test setup.

In a possible embodiment of the method for providing a power delay profile for a fading simulator of a test setup the tap time delays according to the provided power delay profile are implemented by the fading simulator of the test setup using delay chains.

In a possible embodiment of the method for providing a power delay profile for a fading simulator of a test setup the applied bandwidth comprises the bandwidth of the fading simulator of said test setup.

In a possible embodiment of the method for providing a power delay profile for a fading simulator of a test setup the provided power delay profile is derived from original power delay profile as specified in a communication standard by performing a profile transformation while maintaining the channel characteristics of the original power delay profile.

In a possible embodiment of the method for providing a power delay profile for a fading simulator of a test setup the profile transformation comprises performing a Fourier transformation of the original power delay profile as specified in a communication standard into a corresponding target Frequency Domain Correlation.

In a possible embodiment of the method for providing a power delay profile for a fading simulator of a test setup the profile transformation further comprises constructing a hermitian symmetric continuation of the target Frequency Domain Correlation.

In a possible embodiment of the method for providing a power delay profile for a fading simulator of a test setup the profile transformation further comprises performing an inverse Fourier transformation of the constructed hermitian symmetric continuation of the target Frequency Domain Correlation.

In a possible embodiment of the method for providing a power delay profile for a fading simulator of a test setup the profile transformation further comprises performing an optimization to match the Frequency Domain Correlation with the target Frequency Domain Correlation.

In a possible embodiment of the method for providing a power delay profile for a fading simulator of a test setup the target Frequency Domain Correlation comprises a target Frequency Correlation Function.

In a possible embodiment of the method for providing a power delay profile for a fading simulator of a test setup the channel characteristics maintained during profile transformation of the original power delay profile into the provided power delay profile comprise delay spread, frequency correlation function and mean delay.

In a possible embodiment of the method for providing a power delay profile for a fading simulator of a test setup each tap of the power delay profile further comprises azimuth/angle of arrival, azimuth/angle of departure, zenith of arrival, zenith of departure.

In a possible embodiment of the method for providing a power delay profile for a fading simulator of a test setup the provided power delay profile is configured via a user interface of the test setup.

The invention further provides according to a further aspect a fading simulator adapted to apply a power delay profile comprising a predefined set of taps, wherein each tap represents a signal path and has a tap power level and a tap time delay, wherein the delay resolution of the applied power delay profile is an integer multiple of the reciprocate value of a bandwidth of a signal to be faded by the fading simulator or is determined as an integer multiple of the reciprocate value of a fader sampling rate of the fading simulator.

In a possible embodiment of the fading simulator the tap time delays according to the applied power delay profile are implemented by the fading simulator of the test setup using delay chains.

In a possible embodiment of the fading simulator the tap time delays are implemented by means of a cyclic buffer of the fading simulator.

In a possible embodiment of the fading simulator the tap time delay is defined by a difference between a write address and a read address of the cyclic buffer.

In a possible embodiment of the fading simulator the fading simulator comprises a processor adapted to process a transmission signal based on a Tapped Delay Line fading model by introducing delays, power variations, and/or Doppler shifts to create test conditions for evaluating the performance of a device under test under multipath fading conditions.

The provides according to a further aspect a test setup comprising a fading simulator adapted to process an input signal according to a power delay profile comprising a predefined set of taps, wherein each tap represents a signal path and has a tap power level and a tap time delay, wherein the delay resolution of the power delay profile is an integer multiple of the reciprocate value of a bandwidth of a signal to be faded by the fading simulator of the test setup or is determined as an integer multiple of the reciprocate value of a fader sampling rate of the fading simulator of the test setup, wherein the fading simulator of the test setup is adapted to output the processed signal to a device under test to test its performance under fading channel conditions.

In a possible embodiment the test setup is adapted to perform selectable tests comprising throughput testing, MIMO testing and mobility testing.

In a possible embodiment of the test setup the power delay profile applied to the input signal is read from a memory of the fading simulator.

Where appropriate, the above-mentioned configurations and developments can be combined implementations can be combined with each other as desired, as far as this is reasonable. Further possible configurations, developments and implementations of the invention also include combinations, which are not explicitly mentioned, of features of the invention which have been described previously or are described in the following with reference to the embodiments. In particular, in this case, a person skilled in the art will also add individual aspects as improvements or supplements to the basic form of the present invention.

### DESCRIPTION OF FIGURES

In the following embodiment s of the different aspects of the present invention are described in more detail with respect to the enclosed figures.

FIG. 1 shows a schematic diagram for illustrating signal fading;

FIG. 2 shows delayed signal echoes provided by signal fading;

FIG. 3 shows schematically an exemplary test set up according the present invention using a power delay profile provided by the method according to the present invention;

FIG. 4 shows schematically a further exemplary test set up according the present invention using a power delay profile provided by the method according to the present invention;

FIG. 5 shows an exemplary table of taps with associated delays and power levels and fading distribution;

FIG. 6 shows an example of a Power Delay Profile PDP having taps outside the tap delay grid;

FIG. 7 illustrates the mapping of an original Power Delay Profile PDP as shown in FIG. 6 to a Power Delay Profile PDP where all taps are on the tap delay grid;

FIGS. 8-18 show diagrams for illustrating embodiments of the method according to the present invention.

The appended drawings are intended to provide further understanding of the embodiments of the invention. They illustrate embodiments and, in conjunction with the description, help to explain principles and concepts of the invention. Other embodiments and many of the advantages mentioned become apparent in view of the drawings. The elements in the drawings are not necessarily shown to scale.

### DETAILED DESCRIPTION OF EMBODIMENTS

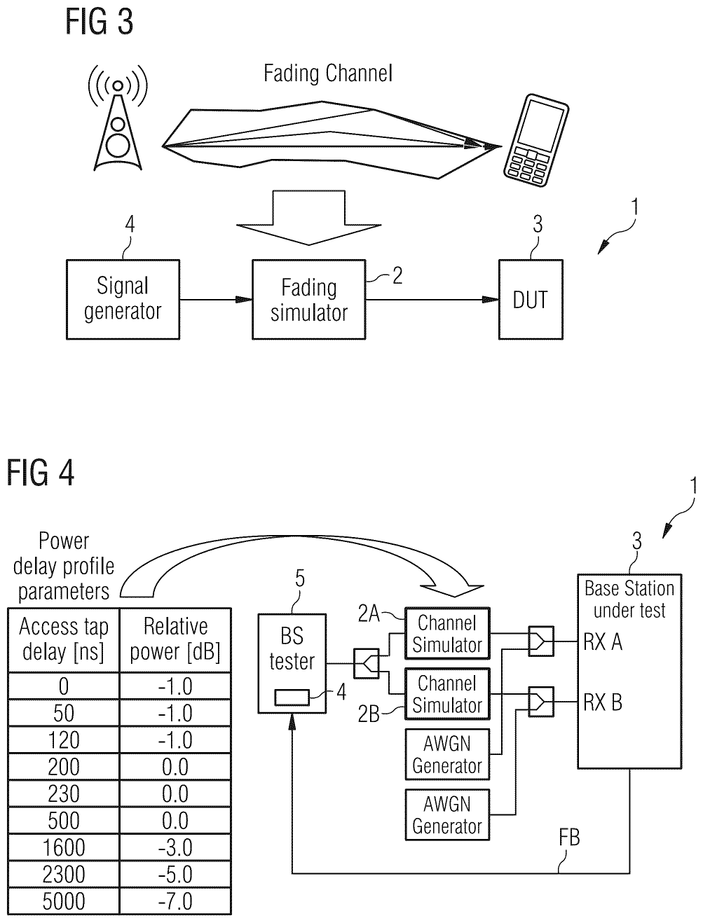

The invention provides according to a first aspect a method for providing a power delay profile (PDP) for a fading simulator as illustrated schematically in FIG. 3. The fading simulator forms part of a test setup. An exemplary test setup 1 is illustrated in the block diagram of FIG. 4. The power delay profile (PDP) comprises a predefined set of taps, wherein each tap represents a signal path and has a tap power level and a tap time delay.

In a possible embodiment the delay resolution (ΔTfad) of the power delay profile (PDP) is determined as an integer multiple of the reciprocate value of a bandwidth (BW) of a signal to be faded by the fading simulator 2 of said test setup 1. The delay resolution (ΔTfad) of the power delay profile PDP) can also be determined as an integer multiple of the reciprocate value of a fader sampling rate fs,fad of the fading simulator of said test setup.

The Power Delay Profile (PDP) and the Frequency Correlation Function (FCF) are two important characteristics used to describe the behavior of wireless communication channels. The Power Delay Profile (PDP) describes how the power of the received signal is distributed across different time delays due to multipath propagation. In a multipath environment, the transmitted signal can take multiple paths to reach the receiver of the device under test 3, each with a different time delay and power level. The PDP captures these effects by providing a statistical characterization of how power is spread over these delay paths.

The Frequency Correlation Function (FCF) is a measure of how the channel response varies as a function of frequency. It is related to the channel's frequency selectivity, which arises from the time dispersion captured by the PDP. Essentially, the FCF indicates how well two frequency components of a signal are correlated after passing through the channel.

The FCF is the Fourier Transform of the Power Delay Profile (PDP). This means that if you know the PDP of a channel, you can derive the FCF, and vice versa.

A narrow PDP (with a short delay spread) corresponds to a wide coherence bandwidth, meaning the channel is frequency-flat.

A wide PDP (with a large delay spread) corresponds to a narrow coherence bandwidth, indicating a frequency-selective channel.

In a possible embodiment of the method for providing a power delay profile PDP for a fading simulator 2 of a test setup 1 the tap time delays according to the provided power delay profile (PDP) are implemented by the fading simulator 2 of the test setup 1 using delay chains.

In a possible embodiment of the method for providing a power delay profile for a fading simulator of a test setup1 the applied bandwidth (BW) comprises the bandwidth of the fading simulator 2 of said test setup 1.

In a possible embodiment of the method the provided power delay profile (PDP) is derived from an original power delay profile (PDP) as specified in a communication standard by performing a profile transformation while maintaining the channel characteristics of the original power delay profile (PDP). The profile transformation can comprise performing a Fourier transformation of the original power delay profile (PDP) as specified in a communication standard into a corresponding target Frequency Domain Correlation (FCF).

The profile transformation can further comprise constructing automatically a hermitian symmetric continuation of the target Frequency Domain Correlation (FCF).

The profile transformation comprises in a possible embodiment performing an inverse Fourier transformation of the constructed hermitian symmetric continuation of the target Frequency Domain Correlation (FCF). The profile transformation comprises in a preferred embodiment an optimization procedure which is performed to match the Frequency Domain Correlation (FCF) with the target Frequency Domain Correlation.

In a possible embodiment of the method for providing a power delay profile for a fading simulator of a test setup the target Frequency Domain Correlation comprises a target Frequency Correlation Function FCF.

The channel characteristics are maintained during the profile transformation of the original power delay profile (PDP) into the provided power delay profile (PDP). These channel characteristics can comprise a delay spread DS, a frequency correlation function FCF and/or a mean delay. The power delay profile (PDP) can—in a possible embodiment—also comprise the azimuth/angle of arrival (AoA), the azimuth/angle of departure (AoD), the zenith of arrival (ZoA) and/or the zenith of departure (ZoD).

In a possible embodiment of the method for providing a power delay profile for a fading simulator 2 of a test setup 1 the provided power delay profile (PDP) can also be configured via a user interface of the test setup 1.

The invention provides according to a further aspect a fading simulator 2 adapted to apply a power delay profile PDP comprising a predefined set of taps, wherein each tap represents a signal path and has a tap power level and a tap time delay. The delay resolution of the applied power delay profile PDP is an integer multiple of the reciprocate value of a bandwidth BW of an input signal to be faded by the fading simulator 2 or is determined as an integer multiple of the reciprocate value of a fader sampling rate of the fading simulator 2. The input signal can be generated by a signal generator 4 of the test setup 1 as illustrated in FIG. 3.

In a possible embodiment of the fading simulator the tap time delays according to the applied power delay profile PDP are implemented by the fading simulator 2 of the test setup 1 using delay chains. The tap time delays can be implemented by means of a cyclic buffer of the fading simulator 2. The tap time delay can in this case be defined by a difference between a write address and a read address of the cyclic buffer. The cyclic buffer of the fading simulator 2 can be implemented by a RAM.

The provides according to a further aspect a test setup comprising a fading simulator 2 adapted to process an input signal according to a power delay profile PDP comprising a predefined set of taps, wherein each tap represents a signal path SP and has a tap power level and a tap time delay, wherein the delay resolution of the power delay profile PDP is an integer multiple of the reciprocate value of a bandwidth of a signal to be faded by the fading simulator 2 of the test setup 1 or is determined as an integer multiple of the reciprocate value of a fader sampling rate of the fading simulator 2 of the test setup 1. The fading simulator 2 of the test setup 1 is adapted to output the processed signal to a device under test 3 to test its performance under fading channel conditions.

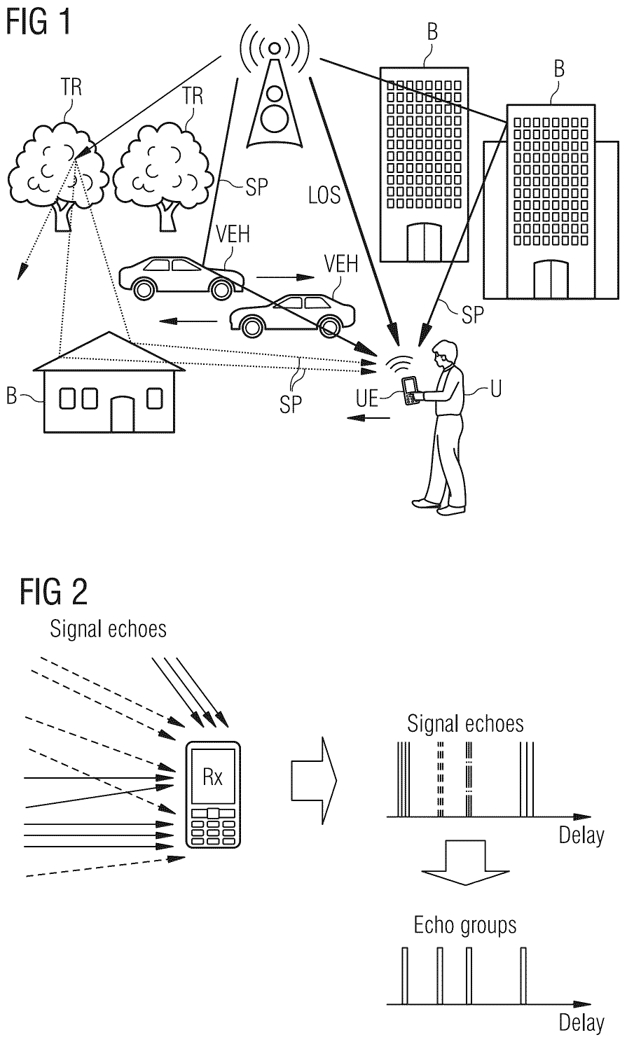

As illustrated schematically in FIG. 1 fading happens during wireless transmission of a signal from a transmitter to a (moving) receiver such as a receiver of a user equipment UE of a user U. There are different ways how a signal can experience fading—for example by shadowing or multipath propagation. Shadowing can be caused by objects such as hills or building blocks that obstruct the signal path between the transmitter and the receiver (“blocking”) as shown in FIG. 1.

The resulting amplitude change seen by the receiver is slow as it moves through the terrain. This kind of fading is thus called slow fading and can be modeled using a lognormal fading profile. Multipath propagation is primarily present in urban environments where the transmitted signal can be reflected or scattered from diverse objects such as trees TR, buildings B or moving vehicles VEH.

The transmitted signal therefore arrives at a receiver not only via the direct line of sight (LOS) as shown in FIG. 1 but via multiple propagation paths. Along each signal path SP, the signal can experience a different time delay, attenuation, phase shift or Doppler frequency shift (caused by motion of transmitter, receiver and/or reflectors). At the receiver, these signal echoes interfere either constructively or destructively, which results in fast fluctuations of the received signal amplitude. This kind of fading is thus called fast fading and can be modelled using e.g. Rayleigh or Rician fading profiles.

Fading can impair the performance of a communications system, since it strongly influences the signal-to-noise ratio SNR of the transmission channel. While the signal power at the receiver of the device under test 3 can drop severely due to fading, the noise power remains the same. As a result, the poor signal-to-noise ratio SNR leads to an increase of bit error rates BERs. Extreme drops in the signal-to-noise ratio SNR may even cause a temporary failure of communications.

In addition to signal loss, multipath fading can introduce inter-symbol interference ISI. Inter-symbol interference ISI occurs when a signal echo transmitting a given symbol arrives at the receiver simultaneously with a different delayed signal echo transmitting a previous symbol. The symbols, transmitted adjacent in time, then interfere with each other. Because fading can greatly impair the performance of a communication link, it is important to test receivers under fading conditions during design and conformance test stages. This requires well-known and repeatable test conditions which can be provided by fading simulators generating realistically faded test signals in the lab.

In wireless communications, the transmitted radio signal travels over many different signal paths SPs to the receiver. The multiple signal echoes travel different distances and suffer different power losses. They therefore arrive at the receiver of the device under test 3 with different time delays and power levels. Some of the signal echoes will have similar delays. All echoes with similar delays can be combined to an echo group exhibiting a specific, average delay. This way, the individual signal echoes can be concentrated to various echo groups, also commonly called taps.

Since each tap represents the sum of multiple signal echoes (arriving at the same time at the receiver), the amplitude distribution for this tap can be, for example, Rayleigh or Rician. The average power level of a tap results from the power levels of all signal echoes contributing to this tap as illustrated in FIG. 2. Generally, the tap power decreases with increasing delay, because the signals arriving at large delays have travelled a larger path, possibly with multiple reflections, and suffered therefore from a greater path loss. The average power and delay of a tap is displayed in a power delay profile PDP. A power delay profile PDP includes all received taps.

Such a power delay profile PDP can be used to model the characteristics of the fading channel. Many wireless communications standards define specific power delay profiles PDPs to be used for performance and conformance testing. In channel simulators, the power delay profile PDP can therefore form the basis for fading simulation. Each tap's delay and power loss as well as the fading profile (e.g. Rayleigh) can be set in the channel fading simulator 2 forming part of a test setup 1 and used for testing a device under test DUT3 such as a mobile phone as illustrated in FIG. 3. The channel fading simulator 2 of the test setup 1 can receive an input signal from a signal generator 4 of the test setup 1.

In real life, the radio signal is subject to a multitude of effects such as multipath propagation, attenuation and shadowing, Doppler shift, etc. a receiver must be able to cope with these conditions. Testing under real-world propagation conditions is therefore important during research and development of a device under test 3 as well as during conformance test phases to ensure proper performance of the product in later everyday use. A radio channel simulator or fading simulator 2 can be used for these tests.

A radio channel simulator 2 is adapted to emulate the propagation conditions of a real radio channel in a laboratory environment as illustrated in the exemplary test setup 1 of FIG. 4 where a base station forms the device under test 3. The signal generator 4 can be integrated in a base station tester 5 as shown in FIG. 4. The base station tester 5 can supply signals to both channel fading simulators 2A, 2B provided for associated reception inputs TXA, RXB of the tested base station 3. The base station tester 5 can also receive a feedback signal FB from the tested base station 3 during fading simulation as illustrated in FIG. 4. The base station tester 5 can comprise a controller adapted to control the channel fading simulators 2A, 2B to apply the fitting power delay profile PDP.

Fading simulation offers the following benefits:

Real world effects can be modelled in a controlled way, which allows testing the receiver under well-defined and controlled conditions.

The simulated fading conditions are reproducible. This allows repeating a measurement any time under the exact same conditions.

Comprehensive testing under various environmental conditions can be performed in the laboratory. The propagation conditions occurring for example indoors, in dense cities, suburban and rural areas, or in high-speed trains can be emulated without the need to travel to these locations and to transport the equipment.

For this reason, the time and cost saving can be substantial compared to field test.

Moreover the complexity of the fading scenario is scalable from simple scenarios with e.g. just one Doppler path up to complex scenarios with e.g. strong multipath propagation and time-varying delays. This allows stressing the receiver gradually, which is especially helpful in the early stages of the development process.

Fading simulation is relevant during the whole development process of a product—including design, integration, validation, and conformance test stages of a device under test 3. For example, all modern mobile communications standards stipulate conformance tests under fading conditions. The specified fading scenarios take power delay profiles PDPs as a basis to model e.g. pedestrian, vehicle and even high-speed mobility in rural, urban and indoor environments. The specified power delay profiles PDPs can be reproduced using a channel fading simulator 2 as illustrated in the exemplary test setup shown in FIG. 4.

Fading simulation is not limited to mobile communication networks. Another application area where fading simulation is e.g. in systems based on software-defined radios. Especially airborne radios are subject to extreme conditions. Long distances between transmitter and receiver introduce considerable signal delays and path attenuations. The high speeds of (supersonic) aircrafts create significant Doppler shifts in the received signal. Simulation of these effects is used to test the performance of radios with the objective of optimizing the design and verifying the compliance to the system specifications.

A user can choose in a preferred embodiment of the test setup 1 from various stored and preconfigured fading scenarios that are in accordance with test scenarios stipulated in communications standards. The provided scenarios emulate stationary as well as dynamic signal propagation conditions (e.g. birth/death or high-speed train scenarios). The user can in a possible embodiment of the test setup 1 also select preconfigured MIMO fading scenarios specified for LTE (EPA, EVA, ETU profiles) or WLAN 802.11n (Modell A to F). All fading parameters including the correlation between the MIMO fading channels can be automatically configured in accordance with the selected scenario.

In a possible embodiment preconfigured fading scenarios are available for the following standards: 3GPP WCDMA, LTE, LTE MIMO, WiMAX™, WiMAX™ MIMO, WLAN, WLAN MIMO, DAB, GSM, CDMA, TETRA, 1xEVDO, NADC, PCN. Scenarios for other scenarios can be preconfigured as well. The Watterson channel model for simulating high-frequency ionospheric channels can also be supported.

Besides the preconfigured scenarios, the user can in a possible embodiment configure custom fading scenarios to meet specific test needs via a user interface of the test system 1. Each fading path can be individually delayed and attenuated. For each fading path, a fading profile such as Rayleigh, Rician, pure Doppler or Gauss can be selected. In addition, lognormal fading (slow fading) can be superimposed onto these fast fading profiles.

By using the method according to the present invention test cases as defined according to a standard such as 3GPP or test cases configured by a customer himself can be carried out with less hardware. This is a significant advantage of the test setup according to the present invention.

In 3GPP test specifications so called Tapped Delay Line (TDL) models are defined for test under fading conditions. Those models define a number of taps (fading paths), where each tap has an associated power and delay as illustrated in the table of FIG. 5.

A Tapped Delay Line (TDL) model can be used to simulate multipath fading in wireless communication systems, such as those defined by 3GPP (3rd Generation Partnership Project) specifications. The TDL model is particularly useful for emulating the complex propagation environments experienced in real-world wireless channels, where transmitted signals undergo reflection, scattering, and diffraction, leading to multiple versions (or “paths”) of the same signal arriving at the receiver with different delays and attenuations. The TDL model simulates a multipath fading environment by representing the channel as a set of discrete paths, each with its own delay, amplitude, and phase shift. Each signal path, referred to as a “tap,” corresponds to a delayed version of the transmitted signal.

In a TDL model the channel impulse response CIR is divided into multiple “taps,” where each tap represents a delayed copy of the signal. Each tap has a specified time delay (relative to the direct path), power (attenuation), and Doppler shift (due to motion between the transmitter and receiver). The fading effects for each tap are usually modelled as a time-varying stochastic process, such as Rayleigh or Rician fading, depending on the environment. Rayleigh fading is used when there is no dominant Line-of-Sight (LOS) path, representing purely scattered signals. Rician fading is used when there is a dominant LOS path in addition to scattered paths. These effects help model real-world conditions like urban environments or rural areas.

In the context of 3GPP, specifically for LTE and 5G NR (New Radio) testing, the TDL model is used to test the performance of communication devices under standardized fading conditions. Some channel models defined by 3GPP using TDL include:

### TDL-A:

Represents a delay line with taps having relatively weak power and small delays, used to model environments with small delay spreads.

### TDL-B:

Similar to TDL-A but with a different distribution of delays and power for the taps, designed for moderate delay spread environments.

### TDL-C:

Features larger delay spreads and is used to represent environments with higher multipath effects.

### TDL-D:

Represents a scenario with a strong Line-of-Sight (LOS) path, often used for Rician fading simulation.

### TDL-E:

Used for extreme delay spread environments.

Each TDL model has a specific number of taps, each with:

Tap delay (τ): The delay associated with each tap, relative to the direct path.

Tap power (P): The relative power of each tap, indicating the strength of each multipath component.

Doppler shift (f_D): The frequency shift due to relative motion between the transmitter and receiver, causing time variations in the channel.

For a given TDL model, the channel impulse response CIR can be expressed as:

$$h ( t , τ ) = {\sum }_{n = 1}^{N} {h}_{n} ( t ) δ ( τ - {τ}_{n} )$$

wherein:
N is the number of taps (paths);
hn(t) is the time-varying complex gain of the n-th tap (this includes fading and Doppler effects);
τn is the delay of the n-th tap;
δ(τ−τn) is the Dirac delta function indicating a delayed copy of the signal.

The TDL model can be used with specific configurations defined by a standard such as 3GPP. Each tap has a pre-defined delay in nanoseconds or microseconds. Each tap is assigned a relative power level, often in dB. The fading effect for each tap can be modeled using a Doppler spectrum, usually modeled as Jakes' spectrum for Rayleigh fading or as a delta function for the LOS component in Rician fading.

TDL models can be used for evaluating the device performance of a device under test DUT 3 under controlled fading conditions. Specifications can use these TDL models for different kinds of testing. Conformance testing is performed to ensuring that devices under test 3 (like smartphones) meet the minimum performance criteria under standardized fading scenarios. Throughput tests are performed to evaluating how a device under test 3 performs in terms of data rates in various fading environments. Multipath fading is tested because it is essential for MIMO (Multiple Input Multiple Output) systems, as it allows realistic simulations of the spatial diversity that MIMO relies on.

In a 3GPP test setup that uses Tapped Delay Line (TDL) fading models, a fader 2 (also referred to as a fading simulator 2 as illustrated in FIG. 3) refers to the device or function that simulates the fading effects experienced in real-world wireless communication channels. The fading simulator 2 of the test setup or test system 1 emulates the behavior of the wireless channel by applying time-varying amplitude and phase changes to the signal, corresponding to the multipath fading conditions specified by the TDL model.

The fading simulator 2 of the test setup 1 performs different functions. The fading simulator 2 of the test setup 1 is adapted to simulate Multipath Fading. The fading simulator 2 generates fading effects according to the characteristics of the channel model being used (e.g., TDL-A, TDL-B, etc.). It applies time-varying changes to the signal to simulate the impact of multipath propagation, where multiple copies of the signal arrive at the receiver with different delays, attenuations, and Doppler shifts. The fading simulator 2 of the test setup 1 applies Tapped Delay Line (TDL) Models. In the TDL model, the channel is represented by a series of taps, each corresponding to a specific delay, power level, and Doppler shift. The fading simulator 2 processes the signal based on the taps. The fading simulator 2 can introduce delays in the signal paths to mimic the arrival times of the different multipath components. The fading simulator 2 can further introduce Doppler shifts to simulate the frequency variation due to relative motion between the transmitter and receiver. The fading simulator 2 can apply fading profiles, such as Rayleigh or Rician fading, to each tap. In Rayleigh fading, there is no dominant line-of-sight (LOS) component, while in Rician fading, there is a dominant LOS path.

The fading simulator 2 of the test setup 1 can control in a possible embodiment the statistical nature of fading. The fading simulator 2 can also operate based on stochastic models of fading, introducing random variations in the signal's amplitude and phase to emulate real-world fading scenarios. The fading is usually time-variant, meaning the changes in the channel conditions evolve over time.

The fading simulator 2 of the test setup 1 is adapted to adjust Channel Parameters. The fading simulator 2 is in a possible embodiment programmable. This allows users to control various parameters of the channel model, such as a maximum Doppler frequency (to simulate different mobility conditions), a number of taps and their corresponding delays and powers (to represent different multipath environments) and an RMS delay spread (to define how widely spread the signal components are in time).

The fading simulator 2 receives an input signal. This signal can be generated by a transmitter or can be provided by a signal generator 4 of the test setup 1. The provided signal is fed into the fading simulator 2. The fading simulator 2 of the test system 1 processes the input signal according to the parameters of the chosen model such as a TDL model. It simulates the channel's impulse response CIR, which consists of multiple paths (taps), each with a different delay and attenuation. The fading simulator 2 provides an output signal. The output of the fading simulator 2 is a signal that has undergone simulated fading, which can be received by a device under test (DUT) 3 to assess its performance under these realistic channel conditions.

3GPP standards for LTE and 5G NR (such as TR 38.901) define various fading models (TDL-A, TDL-B, etc.) for testing mobile devices and base stations. The fading simulator 2 can be used in conformance testing to evaluate how well a device under test 3 can handle specific fading conditions.

Different tests can be performed by the test setup 1, in particular:
Throughput testing where data rates achievable under fading conditions are measured.
MIMO testing where the performance of MIMO systems, is tested and where multipath propagation (fading) is critical for spatial diversity.
Mobility testing can be performed to assess how the device under test 3 performs under different mobility scenarios by varying the Doppler shift introduced by the fader 2.

The fading simulator 2 according to the present invention can be used in a test setup 1. The fading simulator 2 is a component that is adapted to simulate the time-varying fading effects experienced in wireless communication channels. The fading simulator 2 processes the transmitted signal in a possible embodiment based on TDL fading models, introducing delays, power variations, and Doppler shifts to create realistic test conditions for evaluating the performance of mobile devices and systems under multipath fading.

The delays defined in the fading models can be implemented by FIR filtering or by storage elements like a cyclic buffer (RAM). However, for application of FIR filtering one FIR filter is required for each tap leading to a high complexity and high costs with respect to required FPGA resources.

In a preferred embodiment of the method the tap delays are implemented by means of a cyclic buffer realized through a RAM, where the incoming valid signal samples are stored. In this embodiment the delay can be defined by the difference between write and read address.

When delays are implemented by means of storage elements, e.g. a cyclic buffer (RAM) they are restricted to the delay time grid. Due to the implementation with storage elements the realized delays are restricted to a time delay grid having a delay resolution (ΔT fad).

$$n * Δ {T}_{fad} with n ∈ {ℕ}_{0}$$

where the delay resolution φT_{fad} is defined from the signal sample rate f_{s,fad}, i.e.

$$Δ {T}_{fad} = \frac{1}{{f}_{s , fad}}$$

The delay resolution (ΔT fad) of a Power Delay Profile (PDP) refers to the smallest time difference between consecutive multipath components that the system can distinguish. It defines how accurately the time delays of the various multipath components in a channel can be measured or resolved.

The delay resolution (ΔT fad) is related to the bandwidth BW (Bsignal) of the transmitted signal. The delay resolution ΔT fad is given by:

$$Δ {T}_{fad} = \frac{1}{{B}_{signal}}$$

wherein
ΔT fad is the delay resolution;
Bsignal is the bandwidth BW of the transmitted signal.

Wideband signals have better time resolution ΔT fad because they span a large range of frequencies. Therefore, they can distinguish between closely spaced multipath components more accurately.

For example, if a signal has a bandwidth BW of 100 MHz, the delay resolution ΔT fad is:

$$Δ {T}_{fad} = \frac{1}{100 MHz} = 10 ns$$

This means that the system can resolve multipath components with a delay difference as small as 10 nanoseconds.

Narrowband signals have poorer time resolution ΔT fad because they operate over a smaller range of frequencies. In this case, the system cannot distinguish between multipath components that arrive within a short time difference.

For instance, if the signal bandwidth BW is only 1 MHz, the delay resolution ΔT fad is:

$$Δ {T}_{fad} = \frac{1}{1 MHz} = 1 μs$$

Here, the system can only resolve multipath components if their delay difference is at least 1 microsecond, which is less accurate.

A higher bandwidth BW provides better time resolution ΔT fad in the Power Delay Profile PDP, allowing more accurate characterization of multipath effects. This leads to a more detailed and precise representation of the channel's time dispersion and multipath components.

A lower bandwidth BW reduces the delay resolution ΔTfad, leading to a more “blurred” Power Delay Profile PDP where closely spaced multipath components may appear as a single path.

In practical wireless systems, the delay resolution ΔTfad determines how well a receiver can differentiate between multiple signal paths that arrive with small time differences. This is important in applications such as MIMO (Multiple-Input Multiple-Output) systems, where accurate knowledge of the channel multipath structure is crucial for performance optimization.

The delay resolution ΔTfad also impacts the inter-symbol interference (ISI). A better resolution allows the system to more effectively mitigate ISI caused by closely spaced multipath components. The delay resolution ΔTfad is inversely proportional to the signal bandwidth BW, and it plays a crucial role in characterizing the time-domain behaviour of multipath channels through the Power Delay Profile PDP.

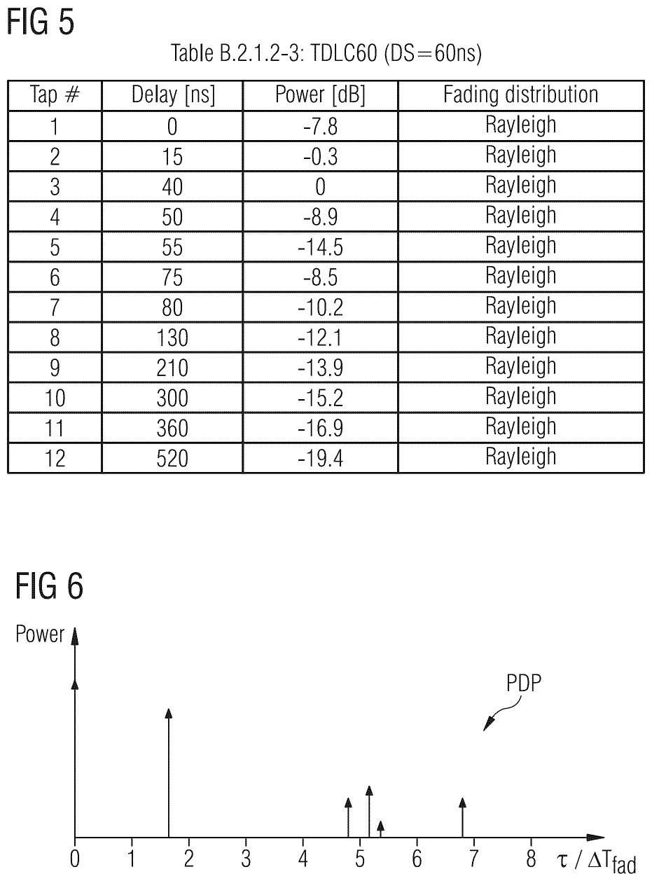

However a given Power Delay Profile (PDP) does not necessarily meet that time delay grid, as illustrated in FIG. 6.

If a power delay profile PDP defines a delay for path k, that does not lie on the delay time grid:

$$∀ n : {τ}_{k} \neq n * Δ {T}_{fad}$$

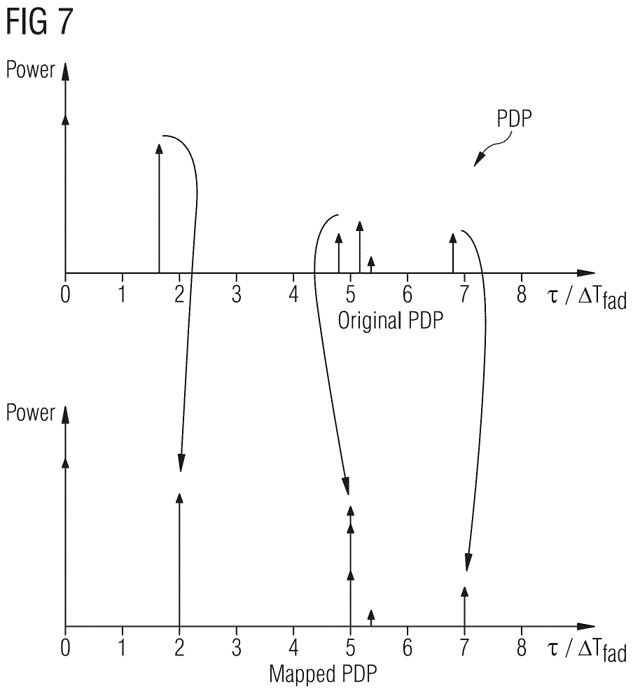

Then τ is replaced with the closest delay on the delay time grid, as illustrated in the example of FIG. 7. This can be expressed through the following processing steps:

At first, determine:

$${n}_{k} = max \{ {argmin}_{n} \vert n * Δ {T}_{fad} - {τ}_{k} \vert \}$$

Then determine:

$${τ}_{k}^{′} = {n}_{k} * Δ {T}_{fad}$$

In order to minimize the error introduced by mapping the delay to the delay time grid as devised above the fader sample rate f_{s,fad} can be chosen as the biggest integer multiple of the native RAT sample rate f_{s,rat} such that the fader sample rate f_{s,fad} remains smaller than the fader clock folk:

$${f}_{s , fad} = N * {f}_{s , rat}$$

where N is determined according to:

$${max}_{N} N * {f}_{s , rat}$$

$$s . t . N ∈ \{ 1 , 2 , 4 , 8 \}$$

$$N \leq \frac{{f}_{clk}}{{f}_{s , rat}}$$

Thus for RATS LTE and NR one has for example:

$${f}_{s , fad} = 245.76 MHz$$

The interpolation by the factor can be accomplished through a HBF.

In a system the number of faded cells which can be realized on the given system may not scale in the same way with signal bandwidth BW like the number of non faded cells. If for example one can realize at maximum L 100 MHz non faded cells on a given hardware then one can realize 2L 50 MHz non faded cells on the same hardware. However, if one can for example at maximum realize M 100 MHz faded cells on a given hardware then one can realize only M (not 2M) 50 MHz faded cells on the same hardware, due to the interpolation in the fader. This is a waste of bandwidth BW, which is already annoying and may be more so when future RFUs double the available RF bandwidth from 1 GHZ to 2 GHZ.

In order to avoid this waste of bandwidth BW, a possible approach could be to run the fader at a lower sample rate, for example:

$${f}_{s , rat} \leq {f}_{s , fad} = 245.76 MHz .$$

A conventional approach for providing accurate time delays is to not restrict oneself to the delay time grid defined by:

$${f}_{s , fad} = {f}_{s , rat}$$

but to use appropriate FIR filtering for the individual taps. However, a main drawback of such a conventional approach are the considerable FPGA resources required for these FIR filters.

The method according to the present invention allows to restrict oneself to the delay time grid defined from the fader sample rate fsfad of the fading simulator 2 and at the same time to maintain the relevant channel characteristics by providing an appropriate PDP power delay profile for the fading simulator 2.

This can be achieved in a possible embodiment by a transformation of a given power delay profile (PDP) specified according to a communication standard into fitting power delay profile (PDP) fitting the delay time grid while maintaining the relevant channel characteristics of the communication channel.

If the fading simulator 2 of the test system 1 runs for example at:

$${f}_{s , rat} \leq {f}_{s , fad} \leq 245.76 MHz$$

the delay time grid can become very rough for small cell bandwidths. It thus can happen that two or more signal paths SPs fall onto the same delay. Those signal paths SPs can then be combined to a single path by adding up their respective powers.

Assume that after delay mapping paths fall onto the same delay. Without loss of generality one can number them with:

$$1 \leq k \leq K , i . e .$$

$${τ}_{1}^{′} = {τ}_{2}^{′} = … = {τ}_{K}^{′} = τ$$

Those signal paths SPs with respective powers

$${σ}_{1}^{2} , {σ}_{2}^{2} , … , {σ}_{K}^{2}$$

can then be combined to a single path having a power

$${σ}^{2} = {\sum }_{k = 1}^{K} {σ}_{k}^{2}$$

and having a delay τ.

For instance if ΔT=5 ns and a power delay profile PDP is given as:

| Tap k | Power σ²ₖ (linear) | Delay τₖ [ns] |
|---|---|---|
| 1 | ${σ}_{1}^{2}$ | 0 |
| 2 | ${σ}_{2}^{2}$ | 8 |
| 3 | ${σ}_{3}^{2}$ | 23 |
| 4 | ${σ}_{4}^{2}$ | 26 |
| 5 | ${σ}_{5}^{2}$ | 27 |
| 6 | ${σ}_{6}^{2}$ | 33 |

After mapping of delays one obtains:

| Tap k | Power σ²ₖ (linear) | Delay τₖ [ns] |
|---|---|---|
| 1 | ${σ}_{1}^{2}$ | 0 |
| 2 | ${σ}_{2}^{2}$ | 10 |
| 3 | ${σ}_{3}^{2}$ | 25 |
| 4 | ${σ}_{4}^{2}$ | 25 |
| 5 | ${σ}_{5}^{2}$ | 25 |
| 6 | ${σ}_{6}^{2}$ | 35 |

After combination of paths one finally obtains:

| Tap k | Power σ²ₖ (linear) | Delay τₖ [ns] |
|---|---|---|
| 1 | ${σ}_{1}^{2}$ | 0 |
| 2 | ${σ}_{2}^{2}$ | 10 |
| 3 | ${σ}_{3}^{2} + {σ}_{4}^{2} + {σ}_{5}^{2}$ | 25 |
| 4 | ${σ}_{6}^{2}$ | 35 |

In a preferred embodiment of the method according to the present invention a more advanced approach for transformation of the specified target power delay profile PDP than the previously described simple path combining is applied. The resulting power delay profile PDP from the simple path combining can be used as a starting point for deriving an optimized power delay profile PDP which maintains some basic fading channel characteristics. The two key parameters that describe the properties of mobile radio channels are the Delay Spread DS and the Frequency Correlation Function FCF.

With the method according to the present invention it is possible to use storage elements for providing delays while avoiding at the same time oversampling in the fader 2 and still meeting the expected throughput performance characteristics which are implied from the fading models as specified in the communication standard.

In a possible embodiment initially it is identified which channel properties are crucial with respect to the throughput performance in a communication system such as an OFDM system. In a possible embodiment of the method according to the present invention an original power delay profile PDP as specified in a communication standard is processed and transformed automatically into a power delay profile PDP which can be implemented by storage elements while avoiding oversampling. It is verified further that the resulting transformed PDP does match crucial channel characteristics defined from the original power delay profile PDP.

The most important channel properties regarding their impact on channel capacity and throughput comprise the delay spread DS and the frequency correlation function, FCF.

The Delay Spread DS is a time domain property which in general terms refers to the time duration over which echoes or multipath components of a radio signal arrive at the receiver. The delay spread gives an indication of the degree of multipath fading a signal experiences, affecting the inter-symbol interference ISI in a communication system. The larger the delay spread DS the more likely it is for the signal to experience significant fading and distortion. The correspondence with the frequency domain is the notion of coherence bandwidth, which is the bandwidth over which the channel can be assumed flat. Coherence bandwidth is related to the inverse of the delay spread DS. The shorter the delay spread DS the larger is the coherence bandwidth.

Delay Spread DS is a time domain measure:

Let the mean delay u be defined

$$μ = \frac{{\sum }_{k} {τ}_{k} * {σ}_{k}^{2}}{{\sum }_{k} {σ}_{k}^{2}}$$

then the root mean squared (rms) delay spread DS is given as

$$DS = \sqrt{\frac{{\sum }_{k} {( {τ}_{k} - μ )}^{2} * {σ}_{k}^{2}}{{\sum }_{k} {σ}_{k}^{2}}}$$

The Frequency Correlation Function, FCF, is a frequency domain property which provides a measure of the similarity between the signal at one frequency and the signal at another frequency. It gives a good understanding of the frequency selectivity of the fading endured by a radio signal.

The Frequency Correlation Function, FCF is given as the Fourier transform of the Power Delay Profile PDP. The Frequency Domain Correlation FCF is a frequency domain measure and is defined as the Fourier transform of the Power Delay Profile PDP as follows:

$$\begin{matrix}FCF ( Δ f ) = ℱ ( PDP ( t ) ) \\ = {\sum }_{k} {σ}_{k}^{2} * {e}^{- i 2 πΔ f {τ}_{k}}\end{matrix}$$

If for example a specific Power Delay Profile PDP is defined from a communication standard such as 3gpp, e.g.:

$${PDP}_{3 gpp} ( t ) = {σ}_{k , 3 gpp}^{2} * δ ( t - {τ}_{k , 3 gpp} )$$

then the corresponding Frequency Correlation Function FCF is obtained by Fourier transform as follows:

$$\begin{matrix}{FCF}_{3 gpp} ( Δ f ) = 𝒫 ( {PDP}_{3 gpp} ( t ) ) \\ = {\sum }_{k} {σ}_{k , 3 gpp}^{2} * {e}^{- i 2 πΔ f {τ}_{k , 3 gpp}}\end{matrix}$$

Since Power Delay Profile PDPs are real functions, a Frequency Correlation Function FCF, which is the Fourier transform of a PDP, is Hermitian symmetric, i.e. for any Frequency Correlation Function FCF:

$$FCF ( Δ f ) = {FCF}^{*} ( - Δ f )$$

where the operator * denotes the conjugate complex

The Frequency Correlation Function FCF is periodic with the inverse of the Power Delay Profile (PDP) delay resolution (ΔT_{PDP}):

$$FCF ( Δ f ) = FCF ( Δ f mod \frac{1}{Δ {T}_{PDP}} )$$

In a possible embodiment of the method according to the present invention matching the Frequency Correlation Function FCF simulated from the fader 2, i.e. FCF fad is matched to the target Frequency Correlation Function FCF defined by the standard such as 3gpp (FCF3gpp).

Due to the properties of the Frequency Correlation Function FCF, i.e. its periodicity and its Hermitian symmetry, it is completely defined on the interval:

$$0 \leq Δ f \leq \frac{1}{Δ {T}_{fad}} = {f}_{s , fad}$$

One can therefore construct as Hermitian symmetric extension of the relevant interval:

$${FCF}_{fad , target} ( Δ f ) = \{ \begin{matrix}{FCF}_{3 gpp} ( Δ f ) , & 0 \leq Δ f \leq \frac{{f}_{s , fad}}{2} \\ {FCF}_{3 gpp} ( - \frac{{f}_{s , fad}}{2} + Δ f mod \frac{{f}_{s , fad}}{2} ) , & \frac{{f}_{s , fad}}{2} < Δ f \leq {f}_{s , fad}\end{matrix}$$

Given that, one can now compute the Power Delay Profile PDP to be realized at the fader by inverse Fourier transform:

$${PDP}_{FTP} ( {τ}_{k , fad} ) = {\sum }_{Δ f} {FCF}_{fad , target} ( Δ f ) * {e}^{i 2 πΔ f {τ}_{k , fad}} = {σ}_{k , FTP}^{2} * δ ( t - {τ}_{k , fad} )$$

The Frequency Correlation Function FCF can be realized by implementing PDP_{FTP}(τ_{k, fad}) through Fourier transformation.

$$\begin{matrix}{FCF}_{FTP} ( Δ f ) = 𝒫 ( {PDP}_{FTP} ( t ) ) \\ = {\sum }_{k} {σ}_{k , FTP}^{2} * {e}^{- i 2 πΔ f {τ}_{k , fad}}\end{matrix}$$

Note that the delays can be chosen arbitrarily, but for the sake of straightforward implementation are chosen to lie on the fader delay grid, which is defined from fader sampling rate f_{s,fad}. For example the delays can be taken as the ones resulting from the simple path combining approach.

From the hermetian symmetric construction of FCF_{fad, target}(Δf) it is ensured that PDP_{FTP}(τ_{k, fad}) is real. It can however happen that some of the values are negative. Since a negative power cannot be implemented a final processing step assures that negative values are transformed to values greater or equal to zero.

In order to assure that a communication signal of a bandwidth BW which needs to be faded experiences the same statistical channel properties as specified by PDP_{3gpp}(t) one has to assure that the bandwidth BW is less or equal the fader sampling rate f_{s,fad}:

$$BW \leq \frac{{f}_{s , fad}}{2} .$$

When the target Power Delay Profile PDP 3gpp are realized based on simple memory delay elements the delay resolution ΔTfad is:

$$Δ {T}_{fad} = \frac{1}{{f}_{s , fad}}$$

i.e. the Frequency Domain Correlation FCF is periodic with the fader sampling rate f_{s,fad}.

One must therefore make sure that fader sampling rate f_{s,fad} of the fader 2 fulfills:

$${f}_{s , fad} \geq 2 BW$$

where BW denotes the signal bandwidth.

If a BW=25 MHz NR cell shall be faded the following requirement has to be fulfilled

$${f}_{s , fad} \geq 2 BW$$

The smallest possible native f_{s,fad} is in this example 61, 44 MHz.

The computation of FCF_{FTP}(Δf) as described previously fits FCE_{FTP}(Δf) to FCF3gpp (Δf) in the frequency range:

$$- \frac{{f}_{s , fad}}{2} \leq Δ f \leq \frac{{f}_{s , fad}}{2}$$

$$- BW \leq Δ f \leq BW$$

With BW denoting the bandwidth of the communication signal to be faded the relevant frequency range however is the subrange.

A further improvement can be achieved in a preferred embodiment by optimizing the fit to that subrange in order to come up with the final FCFfad (Δf) and PDF fad (Tk, fad).

The corresponding optimization problem for matching both Frequency Domain Correlation FCFs reads as follows:

$${min}_{{σ}_{k , fad}^{2}} {‖ ( \begin{matrix}\vert {FCF}_{fad} ( {σ}_{k , fad}^{2} , Δ f ) \vert - \vert {FCF}_{3 gpp} ( Δ f ) \vert \\ {DS}_{fad} ( {σ}_{k , fad}^{2} ) - {DS}_{3 gpp}\end{matrix} ) ‖}_{2}^{2}$$

$$s . t . {σ}_{k , fad}^{2} \geq 0$$

$$Δ f \geq 0$$

$$Δ f \leq BW$$

The optimization problem can written in terms of the optimization variables:

$${min}_{{σ}_{k , fad}^{2}} {‖ ( \begin{matrix}\vert {\sum }_{k} {σ}_{k , fad}^{2} * {e}^{- i 2 πΔ f {τ}_{k , fad}} \vert - \vert {FCF}_{3 gpp} ( Δ f ) ) \vert \\ \sqrt{\frac{{\sum }_{k} {( {τ}_{k , fad} - \frac{{\sum }_{k} {τ}_{k} * {σ}_{k , fad}^{2}}{{\sum }_{k} {σ}_{k , fad}^{2}} )}^{2} * {σ}_{k , fad}^{2}}{{\sum }_{k} {σ}_{k , fad}^{2}}} - {DS}_{3 gpp}\end{matrix} ) ‖}_{2}^{2}$$

$$\begin{matrix}s . t . & {σ}_{k , fad}^{2} \geq 0 \\ & Δ f \geq 0 \\ & Δ f \leq BW\end{matrix}$$

wherein the power σ_{k,FTP}² determined previously can be taken as starting point for the optimization.

The

$${σ}_{k , FTP}^{2}$$

derived in the previous section shall be taken as initial values for the optimization. It is a nonlinear minimization problem subject to bounds, which can be solved e.g. by the trust-region-reflective algorithm.

For example if a DLC60 fading profile as defined from 3gpp is provided and a NR cell of Bandwidth BW=25 MHz has to be faded.

For example one has a Power Delay Profile (PDP) delay resolution (ΔT_{PDP}):

$$Δ {T}_{3 g p p} = 5 ns or equivalently a sample rate fs , 3 gpp = 200 MHz$$

The specified Power Delay Profile PDP_{3gpp} and Frequency Domain Correlation FCF_{3gpp} are given as:

| Tap k | $Power {σ}_{k , 3 gpp}^{2} [ dB ]$ | Delay τ_{k,3gpp} [ns] |
|---|---|---|
| 1 | −7.8 | 0 |
| 2 | −0.3 | 15 |
| 3 | 0 | 40 |
| 4 | −8.9 | 50 |
| 5 | −14.5 | 55 |
| 6 | −8.5 | 75 |
| 7 | −10.2 | 80 |
| 8 | −12.1 | 130 |
| 9 | −13.9 | 210 |
| 10 | −15.2 | 300 |
| 11 | −16.9 | 360 |
| 12 | −19.4 | 520 |

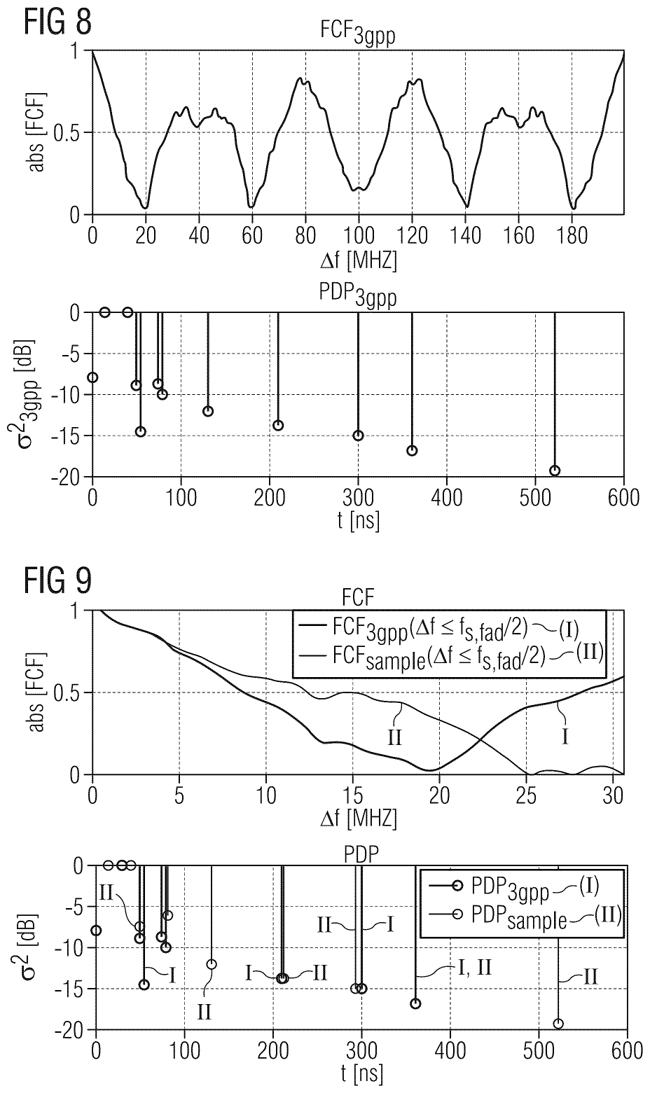

as also illustrated in FIG. 8. As explained above it has to be assured that assured that:

$$BW \leq \frac{{f}_{s , f a d}}{2}$$

One chooses in the given example:

$${f}_{s , fad} = 61.44 MHz = 2 {f}_{s , r a t}$$

After simple path combining according one ends up with the following Power Delay Profile PDPₛᵢₘₚₗₑ(t) and Frequency Domain Correlation FCFₛᵢₘₚₗₑ(Δf) as illustrated in FIG. 9.

| Tap k | $Power {σ}_{k , simple}^{2} [ dB ]$ | Delay τ_{k,simple} [ns] |
|---|---|---|
| 1 | −7.8 | 0 |
| 2 | −0.3 | 16.28 |
| 3 | 0 | 32.55 |
| 4 | −7.84 | 48.83 |
| 5 | −6.26 | 81.38 |
| 6 | −12.1 | 130.21 |
| 7 | −13.9 | 211.59 |
| 8 | −15.2 | 292.97 |
| 9 | −16.9 | 358.07 |
| 10 | −19.4 | 520.83 |

One can cut the relevant part from FCF_{3gpp} (Δf) i.e. the part where

$$0 \leq Δ f \leq \frac{{f}_{s , f a d}}{2}$$

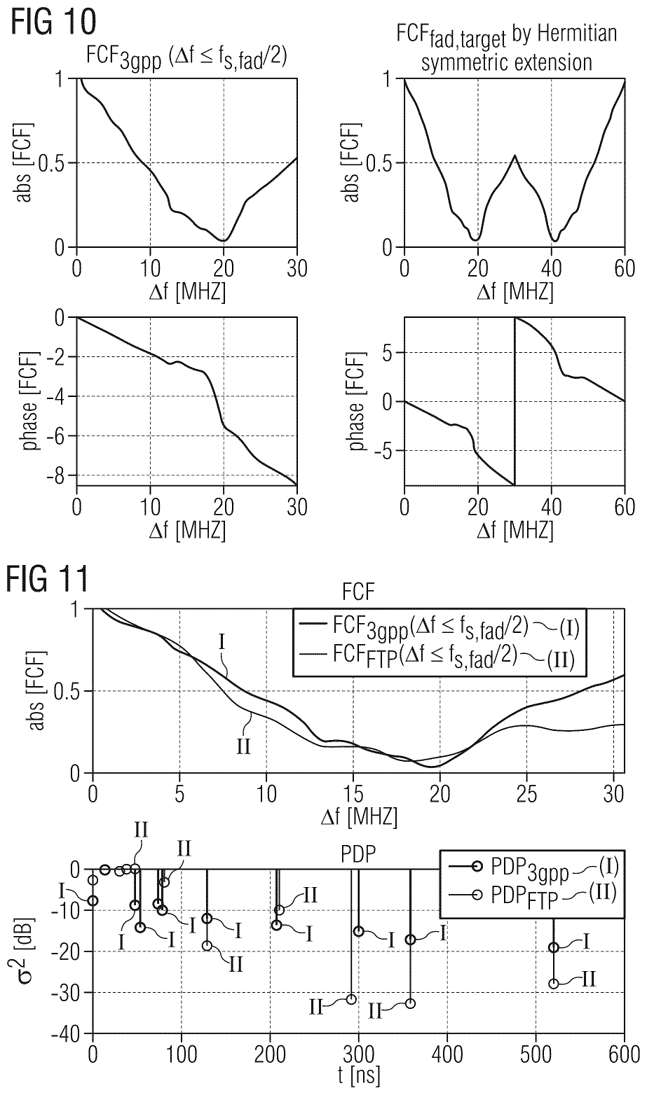

and determine FCF_{fad,target}(Δf) by its Hermitian symmetric continuation as illustrated in FIG. 10.

After Fourier transform processing according tone ends up with the following Power Delay Profile PDP_{FTP}(t) and FCF_{FTP}(Δf) as illustrated in FIG. 11.

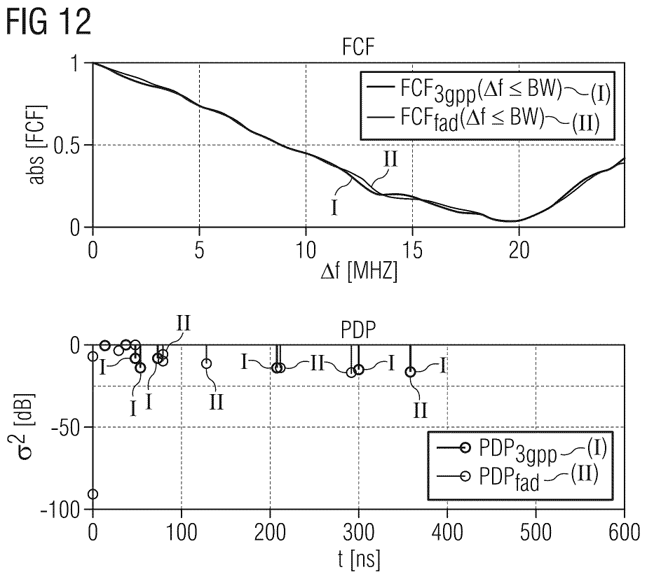

After having solved the optimization problem one finally ends up with the following Power Delay Profile PDP fad(t) and FCF fad (Δf) as illustrated in FIG. 12.

| Tap k | $Power {σ}_{k , fad}^{2} [ dB ]$ | Delay τ_{k,fad} [ns] |
|---|---|---|
| 1 | −91.17 | 0 |
| 2 | −1.08 | 16.28 |
| 3 | −3.27 | 32.55 |
| 4 | 0 | 48.83 |
| 5 | −5.46 | 81.38 |
| 6 | −12.13 | 130.21 |
| 7 | −14.83 | 211.59 |
| 8 | −18.25 | 292.97 |
| 9 | −16.25 | 358.07 |
| 10 | −17.47 | 520.83 |

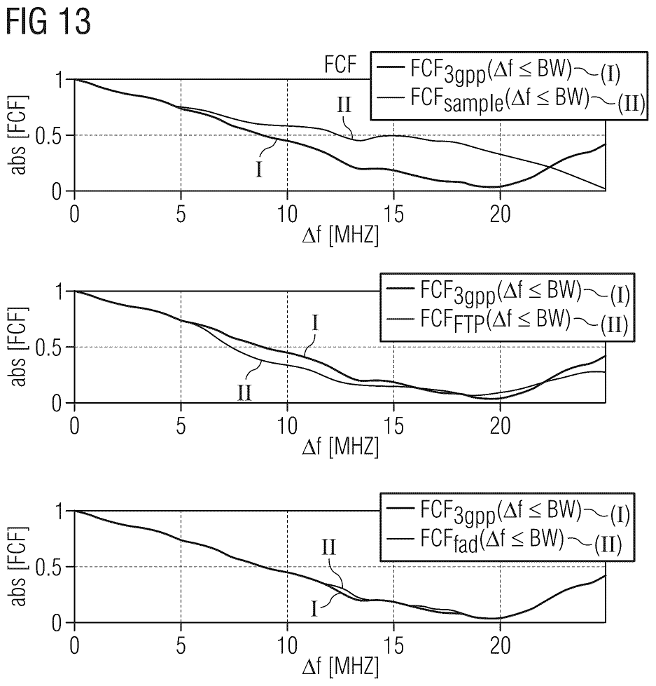

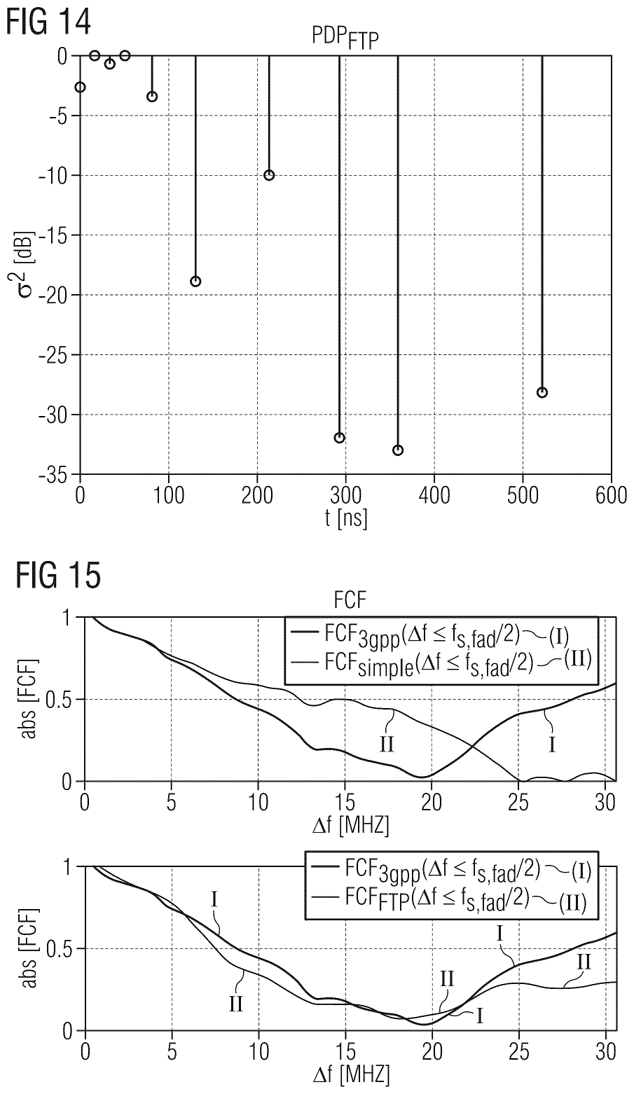

The continuous approach to the target Frequency Domain Correlation FCF (FCF_{3gpp}) achieved by the subsequent processing steps is summarized in FIG. 13.

As a first sub step a simple path combining is conducted, which leads to a rather poor approximation of the target Frequency Domain Correlation FCF.

In a second sub step based on the Tk, simple obtained in the first sub step an inverse Fourier transform of the Hermitian symmetric continuation of the target FCF is performed which leads to Power Delay Profile PDP_{FTP}(t) and FCF (Δf). This already leads to a considerably improved fit to the target FCF.

As illustrated in FIG. 10, a construction by hermitian symmetric extension of the target Frequency Domain Correlation FCF_{3gpp}

$$F C {F}_{3 gpp} ( Δ f \leq \frac{{f}_{s , f a d}}{2} )$$

can be performed.

A determination the Power Delay Profile PDP_{FTP} can be performed by inverse Fourier transform:

$$P D {P}_{F T P ( {τ}_{k , fad} )} = {\sum }_{Δ f} F C {F}_{fad , t a r g e t} ( Δ f ) * {e}^{i 2 π Δ {f}_{{τ}_{k} , fad}}$$

Finally in a third sub step the Frequency Domain Correlation FCF (Δf) obtained in the second sub step is taken as initial point for the solution of a nonlinear bounded optimization problem.

The solution of the optimization problem leads to a Power Delay Profile of the fader PDP_{fad}(t) and to a Frequency Domain Correlation of the fader FCF_{fad}(Δf) which almost perfectly matches the target Frequency Domain Correlation FCF (=FCF_{3gpp}).

A comparison of the target Frequency Domain Correlation FCF_{3pgg}

$$F C {F}_{3 g p p} ( Δ f \leq \frac{{f}_{s , f a d}}{2} )$$

and of

$$F C {F}_{F T P} ( Δ f \leq \frac{{f}_{s , f a d}}{2} )$$

obtained from Fourier transform processing:

$$F C {F}_{F T P} ( Δ f ) = ℱ ( {PDP}_{F T P} ( t ) ) = {\sum }_{k} {σ}_{k , FTP}^{2} * {e}^{- i 2 π Δ f {τ}_{k , fad}}$$

can be performed as illustrated in FIG. 15.

For the final Frequency Domain Correlation to be realized in the fader FCF_{fad} one aims at a better match of final Frequency Domain Correlation FCF_{fad}

$$F C {F}_{f a d} ( Δ f \leq B W )$$

to target final Frequency Domain Correlation FCF_{3gpp}

$$F C {F}_{3 g p p} ( Δ f \leq B W )$$

where the final Frequency Domain Correlation to be realized in the fader FCF_{fad} is given as:

$$F C {F}_{fad} ( Δ f ) = {\sum }_{k} {σ}_{k , fad}^{2} * {e}^{- i 2 π Δ {f}_{{τ}_{k} , fad}}$$

Performing the above matching to and at the same time matching the delay spread DS to:

$$F C {F}_{3 g p p} ( Δ f \leq BW )$$

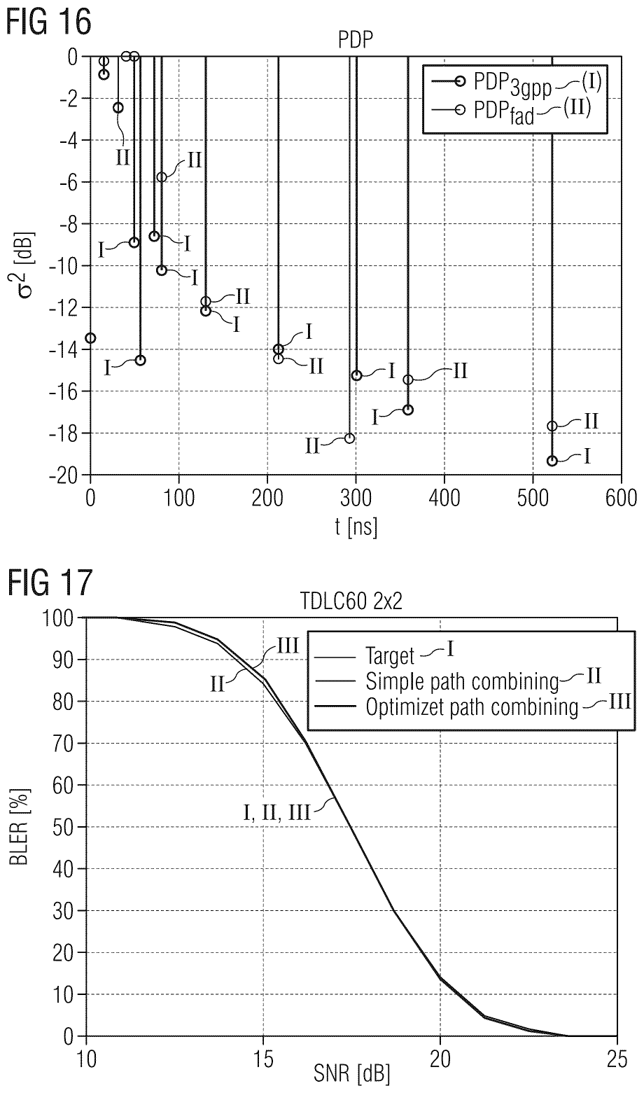

leads to the above indicated nonlinear optimization problem. A solution of the optimization problem is illustrated in the example of FIG. 13. Finally the Power Delay Profile of the fader PDP_{fad} can be compared to the original Power Delay Profile PDP_{3gpp} as illustrated in FIG. 16.

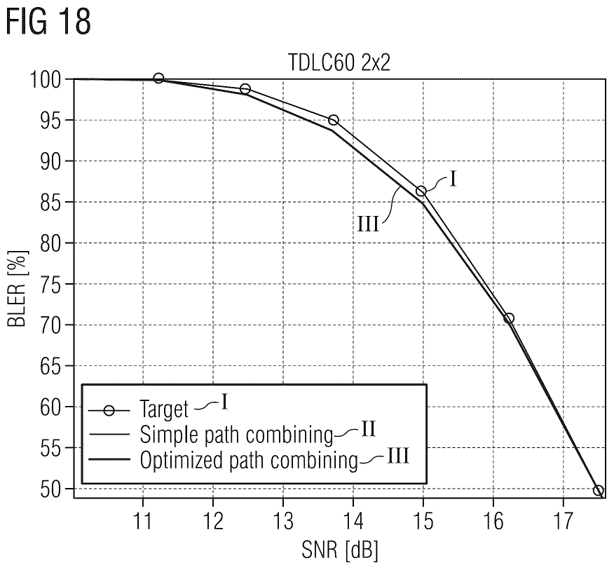

To provide experimental results BLER measurements have been performed for a 25 MHz NR cell impaired by a TCLC60 fading channel and AWGN. The performance of “Simple path combining” and “Optimized path combining”, as described above, are compared to the “Target”, i.e. the performance of the original channel model as specified from 3gpp. Measurement Results for MIMO 2×2, Low Correlation, Doppler 70 Hz, MCS 20, 64QAM are illustrated in FIG. 17 and zoomed in FIG. 18.

As one can observe, the “Simple path combining” approach leads to a deviation from the “Target” performance especially in the low SNR regime. The “Optimized path combining” approach on the other hand matches the “Target” performance very well.

From the measurement results one can conclude that in order to meet the BLER/Throughput performance associated to a defined PDP, i.e. PDP_{3gpp}, one does not have to meet the delays of PDP_{3gpp} exactly. It is sufficient that the implemented Power Delay Profile PDP, i.e. PDP_{fad}, maintains the relevant channel characteristics in time and frequency domain, i.e. FCF_{3gpp} and Delay Spread DS_{3gpp}.

The PDPs defined in the 3gpp test specification imply certain channel properties. These channel properties affect performance measures such as throughput. It shall be expected that the RAT and the receiver architectures implied from that determine which channel properties are the crucial ones w.r.t. the performance measures in question. For example in an OFDM system such as LTE/NR or WLAN due to the inherent frequency domain symbol processing the FCF of the channel has a bigger impact on performance measures than it would have in WCDMA system. It is possible to obtain the same performance measures implied from the 3gpp PDPs by making use of alternative PDPs which are tailored to the baseband processing algorithms and thus are more feasible in terms of implementation. Care must be taken that those alternative PDPs show the same relevant channel properties as the original PDPs. For OFDM systems the channel DS and the channel FCF are the relevant properties.

3GPP defines certain mobile radio channels, compare e.g. TS 38.101-4 for NR or TS 36.101 for LTE, in terms of Power Delay Profiles (PDPs).Those channel models are then applicable for numerous test cases defined in the corresponding test specifications for RF Conformance, RRM, PQA etc.

In a possible embodiment of the method according to the present invention a procedure is performed to transform a specified power delay profile PDP into an alternative transformed power delay profile PDP which is tailored to implementation needs and can thus save an significant amount of the processing power, which would be required from implementing the original power delay profile PDP.

The transformed power delay profile PDP is designed to meet those channel properties from the original power delay profile PDP which are crucial for the performance measures evaluated in the respective test specification, e.g. the data throughput. That means by applying the transformed power delay profile PDP the test purpose of the test setup is still satisfied.

Although the present invention has been described in the above by way of embodiments, it is not limited thereto, but rather can be modified in a wide range of ways. In particular, the invention can be changed or modified in various ways without deviating from the core of the invention.

What we claim is:

1. A method for providing a power delay profile for a fading simulator of a test setup,
wherein the power delay profile comprises a predefined set of taps, wherein each tap represents a signal path and has a tap power level and a tap time delay,
wherein the delay resolution of the power delay profile is determined as an integer multiple of the reciprocate value of a bandwidth of a signal to be faded by the fading setup or is determined as an integer multiple of the reciprocate value of a fader sampling rate of the fading simulator of said test setup.

2. The method of claim 1, wherein the tap time delays according to the provided power delay profile are implemented by the fading simulator of the test setup using delay chains.

3. The method for providing a power delay profile for a fading simulator of a test setup according to claim 1, wherein the applied bandwidth comprises the bandwidth of the fading simulator of said test setup.

4. The method of claim 1, wherein the provided power delay profile is derived from original power delay profile as specified in a communication standard by performing a profile transformation while maintaining the channel characteristics of the original power delay profile.

5. The method of claim 4, wherein the profile transformation comprises performing a Fourier transformation of the original power delay profile as specified in a communication standard into a corresponding target Frequency Domain Correlation.

6. The method of claim 5, wherein the profile transformation further comprises constructing a hermitian symmetric continuation of the target Frequency Domain Correlation.

7. The method of claim 6, wherein the profile transformation further comprises performing an inverse Fourier transformation of the constructed hermitian symmetric continuation of the target Frequency Domain Correlation.

8. The method of claim 4, wherein the profile transformation further comprises performing an optimization to match the Frequency Domain Correlation with the target Frequency Domain Correlation.

9. The method of claim 5, wherein the target Frequency Domain Correlation comprises a target Frequency Correlation Function FCF.

10. The method of claim 4, wherein the channel characteristics maintained during profile transformation of the original power delay profile into the provided power delay profile comprises delay spread, frequency correlation function and mean delay.

11. The method of claim 1, wherein each tap of the power delay profile further comprises an azimuth/angle of arrival, an azimuth/angle of departure, a zenith of arrival, a zenith of departure.

12. The method of claim 1, wherein the provided power delay profile is configured via a user interface of the test setup.

13. A fading simulator adapted to apply a power delay profile comprising a predefined set of taps,
wherein each tap represents a signal path and has a tap power level and a tap time delay,
wherein the delay resolution of the applied power delay profile is an integer multiple of the reciprocate value of a bandwidth of a signal to be faded by the fading simulator or is determined as an integer multiple of the reciprocate value of a fader sampling rate of the fading simulator.

14. The fading simulator of claim 13, wherein the tap time delays according to the applied power delay profile are implemented by the fading simulator of the test setup using delay chains.

15. The fading simulator of claim 13, wherein the tap time delays are implemented by means of a cyclic buffer of the fading simulator.

16. The fading simulator of claim 15, wherein the tap time delay is defined by a difference between a write address and a read address of the cyclic buffer.

17. The fading simulator of claim 13, wherein the fading simulator comprises a processor adapted to process a transmission signal based on a Tapped Delay Line fading model by introducing delays, power variations, and/or Doppler shifts to create test conditions for evaluating the performance of a device under test under multipath fading conditions.

18. A test setup comprising a fading simulator adapted to process an input signal according to a power delay profile comprising a predefined set of taps,
wherein each tap represents a signal path and has a tap power level and a tap time delay,
wherein the delay resolution of the power delay profile is an integer multiple of the reciprocate value of a bandwidth of a signal to be faded by the fading simulator of the test setup or is determined as an integer multiple of the reciprocate value of a fader sampling rate of the fading simulator of the test setup, wherein the fading simulator of the test setup is adapted to output the processed signal to a device under test to test its performance under fading channel conditions.

19. The test setup of claim 18, wherein the test set up is adapted to perform selectable tests comprising throughput testing, MIMO testing and mobility testing.

20. The test setup of claim 18, wherein the power delay profile applied to the input signal is read from a memory of the fading simulator.
